(19) United States
(12) Patent Application Publication
(10) Pub. No.: US 2008/0133305 A1
(43) Pub. Date: Jun. 5, 2008

(54) SYSTEM AND METHOD FOR FACILITATING RESALE ACTIVITY OF ITEMS

(75) Inventors: John Andrew Yates, McLean, IL (US); Matthew Scott Walsh, San Carlos, CA (US)

Correspondence Address: PERKINS COIE LLP;PATENT-SEA, P.O. BOX 1247, SEATTLE, WA, 98111-1247, US

(73) Assignee: Skudr.com, Inc., McLean, IL (US)

(21) Appl. No.: 11/849,182

(22) Filed: Aug. 31, 2007

Related U.S. Application Data
(60) Provisional application No. 60/824,395, filed on Sep. 1, 2006.

(51) Int. Cl. G06Q 30/00; G06F 17/00

(52) U.S. Cl. 705/8; 705/27

(57) ABSTRACT

A system and method that facilitates the resale activity of items is disclosed. In some embodiments, the system enables sellers to generate “for sale” record data using standardized item descriptions, individual item information, and/or seller-provided information. The generated “for sale” records are distributed by the system to online auctions and/or fixed-price network sites. The system generates customized offers and incentives for use in attracting prospective sellers and buyers, allows buyers to search one or more databases of “for sale” records, and assists with collection and escrow activities after a buyer and seller have agreed to complete a sale. To facilitate the delivery of an item once the item has been sold, the system provides item information and transaction information to a shipper to enable the shipper to ship packing materials to the seller. The seller may then ship the sold item to the buyer using the provided packing materials.

### TECHNICAL FIELD

This invention relates generally to the management of item resale activity, and more specifically to the coordination of resale activity relating to online auctions and offers for sale via network sites.

### BACKGROUND

The Internet has become a popular medium for sales activity. When users browse the World Wide Web, for instance, advertisements and offers to sell goods and services are presented to the user at nearly every web site. Online sales activity has increased at an accelerating rate over the past decade.

Online auction sales have accelerated at a similar rate. Online auction market leader eBay® has reported that “gross merchandise volume,” or the total value of all successfully closed items on its web sites, exceeded $10 billion in one quarter. eBay® reports that confirmed registered users of its web sites number in the hundreds of millions. Thus, it is apparent that online auction and sales activity is likely to grow steadily in the future, encompassing products and services in almost every conceivable category.

The significant economic opportunity presented by this and other forms of Internet commerce has attracted a large number of merchants offering competing and complementary products and services. For example, sellers with significant sales volume generated via online auction web sites are continually seeking improved auction management and listing tools. However, such tools apply inconsistent approaches to the problem of post-sale logistics and are usually inappropriate for so-called “casual” sellers lacking selling resources, infrastructure and/or expertise.

For another example, “drop-off stores” offer prospective sellers the ability to sell via online auction web sites without spending the significant time and effort required to register and create an online listing. “Drop-off stores” typically charge the seller a fixed fee and/or a fee proportional to the eventual sales price of an item dropped-off, and forward the net amount (e.g., sales price less fees) to the seller after the transaction is completed. However, these stores typically charge exorbitant fees on an item-by-item basis (e.g., in excess of 30% of item sale price) to recoup their overhead expenses including physical storefront and warehouse facility costs.

The dual problems of pre-sale preparation and post-sale logistics associated with online auction and fixed-price sales web sites tend to discourage many users of these channels of commerce. Sellers generally are forced to contend with intrusive enrollment requirements, complex listing procedures, perpetually increasing fees, and continually tightening restrictions on sellers' freedom to interact with buyers. Accordingly, the concomitant increase in transaction costs are passed on to the buyer, who usually must navigate among the offerings using an inflexible user interface, expending large amounts of time and energy.

Therefore, there is a need and desire in the marketplace for an online commerce management system that will simplify the process of selling one or more items online and simultaneously attract economically-minded buyers. The desired solution should apply a consistent approach to post-sale logistics including order processing and shipping, and should be suitable for use by a wide variety of sellers.

### SUMMARY

A system and method that facilitates the resale activity of items via online auctions and fixed-price network sites is disclosed. In some embodiments, the system enables sellers to generate “for sale” record data using standardized item descriptions, individual item information, and/or seller-provided information. The generated “for sale” records are distributed by the system to online auctions and/or network sites offering the fixed-price sale of items. The system generates customized offers and incentives for use in attracting prospective sellers and buyers, allows buyers to search one or more databases of “for sale” records, and assists with collection and escrow activities after a buyer and seller have agreed to complete a sale. To facilitate the delivery of an item once the item has been sold, the system provides item information and transaction information to a shipper to enable the shipper to ship packing materials to the seller. The seller may then easily ship the sold item to the buyer using the provided packing materials. By providing consistent and functional coordination of post-sales activity, the system relieves sellers and buyers of associated hassles. The system may be implemented using a simplified interface for use by a wide variety of sellers and buyers, and significant economies of scale (e.g., in shipping) provide improved service for a reasonable cost.

For example, a web site generated by the system may be visited by a seller wishing to sell a particular item. The seller may input an identifier that corresponds to the item. Identifiers include Global Trade Item Numbers (GTIN), which include Universal Product Codes (UPC), European Article Numbers (EAN) and Japanese Article Numbers (JAN) and International Standard Book Numbers (ISBN) as well as any other type of identifier that can identify an item, such as a title or description of the item. Alternatively, the seller may identify the item using drill-down menus or other means of description. The seller may input preferred selling price and other information relevant to the individual item desired to be sold, optionally guided by standardized item information and sales data provided by the web site. The seller may input seller identification information to facilitate post-sales activity. The system may then generate a “for sale” listing at one or more online auction or fixed-price web sites. A prospective buyer may request a search of items matching or similar to the seller's item. The system may then generate a customized presentation of search results for the prospective buyer, including information relating to the “for sale” listing. If and/or when the buyer consents to the sale, the system may collect the payment, place the funds in escrow, and generate shipping requests based on buyer and seller identification information. The system sends the shipping requests to a shipper that furnishes and ships packaging, packing, and mailing supplies (e.g., box, foam peanuts, shipping instructions, and/or pre-addressed shipping labels, etc.) to the seller so that the seller may easily ship the item to the buyer. In alternate embodiments, the shipper may be provided some or all packaging, packing, and mailing supplies in addition to instructions to enable and direct the shipper to ship same to the seller. Upon receipt of the item, the buyer may signal acceptance to release the escrowed funds to the seller, less transaction fees to the system operator. When a new item is released or made available for sale that is related to a previously-sold item, both the seller and buyer may be notified of new item details, such as technical specifications and improvements over the previously-sold item, and/or offered incentives to do business through the web site again.

In some embodiments, a system operator may form partnerships with retailers, producers, and/or third party providers of items or associated data to facilitate resale activity. In some embodiments, the system may receive item information (e.g., photos, dimensions, weight, and technical specifications) from a retailer or producer and provide one or more commissions to the retailer or producer corresponding to sold items associated with the retailer or producer. The system may also authorize the retailer or producer to inform customers and others of the operator's services, provide sales data to the retailer or producer, suggest to the end consumer that the actual cost of an item may be the purchase price less eventual resale proceeds, and provide access to databases by the retailer or producer to assist in selling returned and/or refurbished items. In alternate embodiments, item information or other data associated with an item may be received from or via a third party data provider to which a fee may be paid by a system operator or others for access to the item information or other data.

In some embodiments, the system may provide specialized resale tools to sellers and/or buyers to facilitate resale activity. In some embodiments, the system provides at least one software tool to a seller, receives from the seller additional item information generated using the software tool, and updates one or more databases including item information and/or “for sale” records to include the additional item information. For example, the system may provide a web-based software tool enabling a user to create images and/or add information to an existing image of an item offered for sale, including highlighting or drawing attention to specific images or portions of an image and/or textual information describing characteristics (e.g., upgrades, add-ons, flaws, blemishes, etc.) of or associated with the offered item. In this way, a seller, a system operator, or others may emphasize quality, attention to detail, accuracy, or other factors relevant to a resale transaction, thus inducing trust and facilitating additional resale activity.

The invention includes computer-implemented methods, machine-readable media, computerized systems, and computers of varying scopes. Other aspects, embodiments and advantages of the invention, beyond those described here, will become apparent by reading the detailed description and with reference to the drawings.

### BRIEF DESCRIPTION OF THE DRAWINGS

FIG. 1 is a simplified schematic diagram of a representative operating environment in conjunction with which embodiments of the invention may be practiced.

FIG. 2 is a simplified block diagram illustrating a representative system for managing online resale activity in conjunction with which embodiments of the invention may be practiced.

FIG. 3 is a simplified flow diagram illustrating an exemplary method of “for sale” record generation that may be used in accordance with an embodiment of the invention.

FIG. 4 is a simplified flow diagram illustrating an exemplary method of providing “for sale” record information for use by prospective buyers that may be used in accordance with an embodiment of the invention.

FIG. 5 is a simplified flow diagram illustrating an exemplary method of post-sale coordination that may be used in accordance with an embodiment of the invention.

FIG. 6 is a simplified flow diagram illustrating an exemplary method of retailer partnering that may be used in accordance with an embodiment of the invention.

FIG. 7 is a simplified flow diagram illustrating an exemplary method of producer partnering that may be used in accordance with an embodiment of the invention.

FIG. 8 is a simplified flow diagram illustrating an exemplary method of informing users of new item offers that may be used in accordance with an embodiment of the invention.

FIG. 9 is a simplified flow diagram illustrating an exemplary method of facilitating resale activity that may be used in accordance with an embodiment of the invention.

FIG. 10 is a simplified flow diagram illustrating an exemplary method of shipping packaging materials to a seller that may be used in accordance with an embodiment of the invention.

FIGS. 11A-11C illustrate exemplary interfaces for generating “for sale” record information in accordance with an embodiment of the invention.

FIG. 12 illustrates another exemplary interface for generating “for sale” record information in accordance with an embodiment of the invention.

FIG. 13 illustrates an exemplary “for sale” listing in accordance with an embodiment of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as processing or computing or calculating or determining or displaying or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Operating Environment

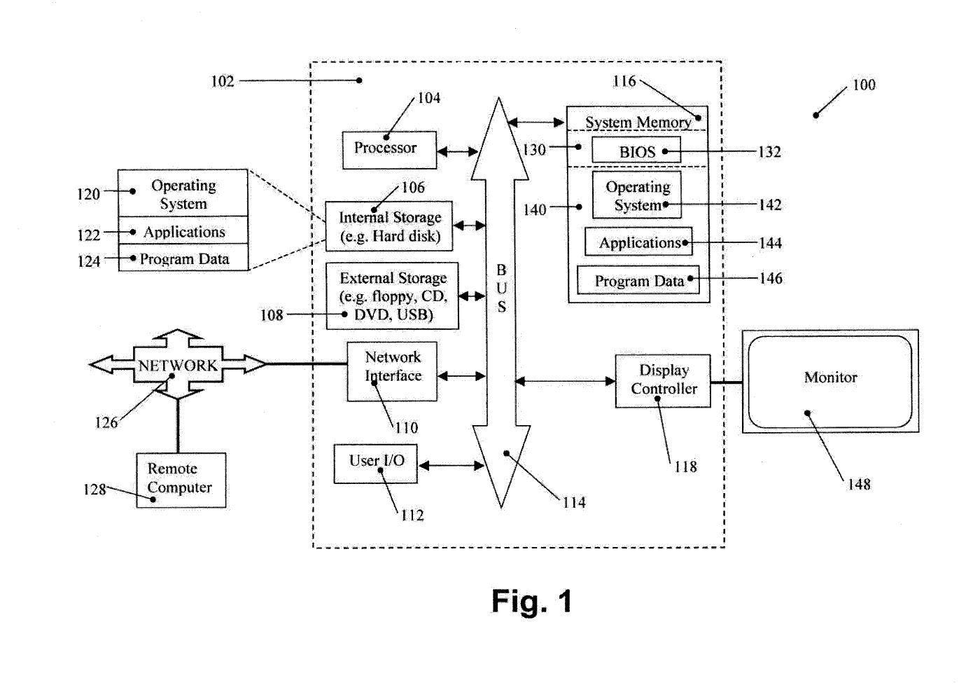

Referring to FIG. 1, a diagram of the hardware and operating environment in conjunction with which embodiments of the invention may be practiced is shown. The description of FIG. 1 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PC's, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The exemplary hardware and operating environment 100 of FIG. 1 for implementing the invention includes a general purpose computing device in the form of a computer 102, including a processor 104, a system memory 116, and a system bus 114 that operatively couples various system components including the system memory to the processor 104. There may be only one or there may be more than one processing unit included in processor 104, such that the processor 104 of computer 102 comprises a single central-processing unit (CPU), or a plurality of processing units, commonly referred to as a parallel processing environment. The computer 102 may be a conventional computer, a distributed computer, or any other type of computer; the invention is not so limited.

The system bus 114 may be any of several types of bus structures including a memory bus or memory controller, a peripheral bus, and a local bus using any of a variety of bus architectures. The system memory 116 may also be referred to as simply the memory, and includes read only memory (ROM) 130 and random access memory (RAM) 140. A basic input/output system (BIOS) 132, containing the basic routines that help to transfer information between elements within the computer 102, such as during start-up, is stored in ROM 130. The computer 102 further includes an internal storage device 106, e.g., a hard disk drive, for reading from and writing to a hard disk, not shown, an external storage device 108, e.g., a floppy, CD, DVD, or USB device, for reading from or writing to a removable medium such as a compact disc, digital video disc, flash memory, or other optical, magnetic, or electronically programmable media.

The internal storage device 106 and external storage device 108 are connected to the system bus 114. The storage devices and their associated computer-readable media provide nonvolatile storage of computer-readable instructions, data structures, program modules and other data for the computer 102. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the internal storage device 106, external storage device 108, ROM 130, or RAM 140, including an operating system 120, 132, one or more application programs 122, 144, and program data 124, 146. A user may enter commands and information into the personal computer 102 through user input/output devices 112 such as a keyboard and pointing device. Other input devices (not shown) may include a microphone, joystick, game pad, satellite dish, scanner, or the like. These and other input devices are often connected to the processor 104 through a serial port interface that is coupled to the system bus 114, but may be connected by other interfaces, such as a parallel port, game port, or a universal serial bus (USB). A monitor 148 or other type of display device is also connected to the system bus 114 via an interface, such as a display controller 118. In addition to the monitor, computers typically include other peripheral output devices (not shown), such as speakers and printers.

The computer 102 may operate in a networked environment using logical connections to one or more remote computers, such as remote computer 128. These logical connections are achieved by a communication device coupled to or a part of the computer 102; the invention is not limited to a particular type of communications device. The remote computer 128 may be another computer, a server, a router, a network PC, a client, a peer device or other common network node, and typically includes many or all of the elements described above relative to the computer 102. The logical connections depicted in FIG. 1 include a network 126, which may include one or both of a local-area network (LAN) and a wide-area network (WAN). Such networking environments are commonplace in office networks, enterprise-wide computer networks, intranets and the Internet, which include nearly all types of networks.

When used in a LAN-networking environment, the computer 102 is connected to the network 126 through a network interface 110, which is one type of communications device. When used in a WAN-networking environment, the computer 102 may include a network interface 110 or a modem (not shown), a type of communications device, or any other type of communications device for establishing communications over a wide area network such as the Internet. In a networked environment, program modules depicted relative to the personal computer 102, or portions thereof, may be stored in the remote memory storage device. It is appreciated that the network connections shown are exemplary and other means of and communications devices for establishing a communications link between the computers may be used.

### Resale System and Associated Sites

In this section of the detailed description, an overview is provided of an exemplary system for managing online resale activity, through one or more sites. A site as used herein may be divided into at least a number of pages, such that the site is able to display information on one or more of the pages. Each page can include text, graphics, as well as links to other pages, both within and without the site. A site may be a web site, accessible on the World Wide Web of the Internet via a Uniform Resource Locator (URL) address, such as http://www.site.com/index. A site may also be a network site accessible via any other public or private networks, such as intranets or extranets.

The World Wide Web is referred to in shorthand as the Web, and is an Internet facility that links documents locally and remotely. A web document is called a web page, and links in the page let users jump from page to page (hypertext) whether the pages are stored on the same server or on servers around the world. The pages are generally accessed and read via a web browser computer program. Web pages are maintained at web sites, which are computers that support the Web's HyperText Transport Protocol (HTTP). When a web site is accessed, its home page is usually first viewed, which is a HyperText Markup Language (HTML) document that serves as an index, or springboard, to the site's contents. The home page and other web site pages may use, for example, Cascading Style Sheets (CSS) and JavaScript technologies on the client side, as well as software tools including but not limited to web server software (e.g., Microsoft® Internet Information Services (IIS), Apache), databases (e.g., MySQL, Microsoft® SQL Server), and scripting languages (e.g., PHP, ASP, Python) on the server side.

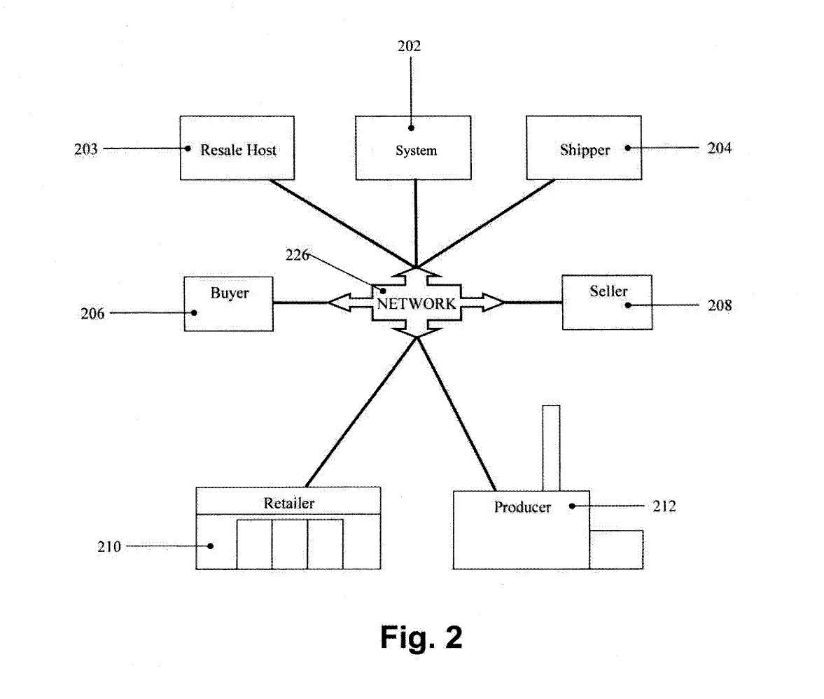

FIG. 2 depicts an environment in which a system 202 is used to facilitate online resale activity. The system 202 may be coupled via a network 226 to a resale host 203, a shipper 204, at least one buyer 206, at least one seller 208, a retailer 210 and a producer 212.

In operation, the system 202 may receive a request to sell an item from a seller 208 and may generate a “for sale” record. The “for sale” record data may be generated using standardized item descriptions, individual item information, and/or seller-provided information. The system 202 may provide the “for sale” record data to one or more resale hosts 203, for example sites implementing online auctions or fixed-price offers for sale via the network 226. The system 202 may provide customized offers and incentives for use in attracting prospective sellers 208 and buyers 206. Upon request by a prospective buyer 206, the system 202 may search one or more databases of “for sale” records on behalf of a prospective buyer 206, and provide the search results to facilitate a possible sale. If and when a buyer 206 and a seller 208 agree to complete a sale, the system 202 may assist with collection and escrow activities, and may provide item information and transaction information to a shipper 204 to assist shipping of packing materials to the seller 208 for ease of transporting the sold item to the buyer 206. In some embodiments, the operator of the system 202 may provide packing materials (e.g., shipping labels, shipping instructions and/or information, boxes, padding, etc.) to the shipper 204 in addition to instructions to enable and direct the shipper 204 to ship the provided packing materials to the seller 208 for ease or transporting the sold item to the buyer 206. It should be apparent that the shipper 204 may or may not include and/or function as a fulfillment entity that receives orders, prints shipping labels, assembles containers, boxes, and other cartons for shipping/transport to the seller 208. The system 202 may also provide new and/or alternative item information to buyers 206 and sellers 208 known to have a current or former interest in similar items.

Alternatively or in addition to the above, the operator of the system 202 may form partnerships with one or more retailers 210 and/or producers 212 of items to facilitate resale activity. In operation, the system 202 may receive item information from a retailer 210 or a producer 212. For example, the system 202 may receive item information from an online auction website such as eBay® or other sources that may aggregate item information. The item information received may include standardized description information associated with the item, such as photos of the item, item dimensions and weight, and/or technical specifications of the item. The item information may include other marketing, sales, and/or other data. The system 202 may provide to the retailer 210 or producer 212 a commission corresponding to each item sold via the system 202 that was formerly associated with the retailer or producer as an incentive for the retailer 210 or producer 212 to inform customers and others of the system 202 and its respective services and capabilities. The system 202 may provide sales data to the retailer 210 or producer 212 including, for example, average resale price, resale volume for particular items, etc. Each of the system 202, resale host 203, shipper 204, seller 208, buyer 206, retailer 210, and producer 212 may suggest to an end consumer (e.g., another buyer 206) that the actual cost of an item may be the purchase price less eventual resale proceeds. The system 202 may provide access to one or more item information and “for sale” databases to the retailer 210 or producer 212 to assist in selling or evaluating potential sale of items returned to and/or refurbished by a retailer 210 or a producer 212. Of course, it should be immediately appreciated by those of ordinary skill in the art that the role of the retailer 210 or producer 212 may be filled by any retailer, producer, manufacturer, originator, source of content, or other party, with or without a former association to the item sold via the system 202 or otherwise.

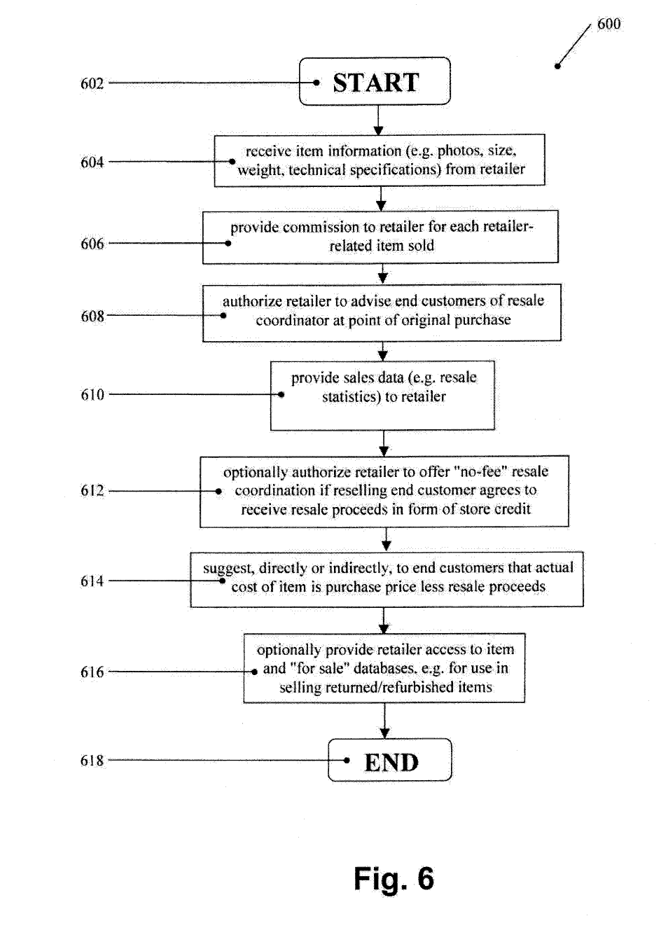

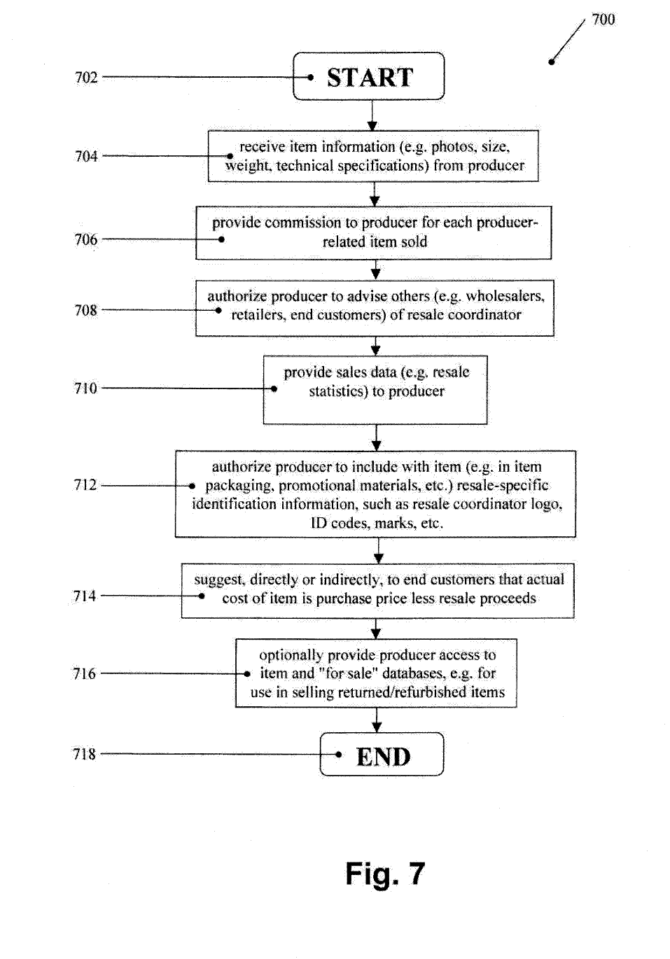

FIGS. 6 and 7 illustrate exemplary methods for retailer and producer partnering, respectively. Referring to FIG. 6, a method for retailer partnering is described and generally designated 600. The method 600 begins at item information receiving step 604, in which the system may receive standardized item descriptions and other information supplied by the retailer, such as photos, item dimensions and weight, and technical specifications of the item. In alternate embodiments, item descriptions and other information may be received from other parties instead of or in addition to the retailer, for example a third party data provider from which the system may receive item data such as textual and/or graphical information related to the item in exchange for a fee payment. In commission provision step 606, the system provides a commission to the retailer each time an item formerly associated with the retailer is sold via a site generated by the system. In first authorization step 608, the system may authorize the retailer to advise end customers (e.g., buyers) of the existence of a site or sites generated by the system and that items purchased at the retailer may later be resold via the site or associated sites. In sales data provision step 610, the system may feed back to the retailer sales statistics and other information, optionally limited to data regarding items formerly associated with the retailer. In second authorization step 612, the system may optionally authorize the retailer to offer system services at no charge to the seller and/or buyer in exchange for seller agreeing to receive eventual resale proceeds in the form of retailer store credit. In suggestion step 614, the system, retailer, buyer, and/or seller may suggest to end customers that the actual cost of any item is the purchase price less eventual resale proceeds, for example in order to induce further sales activity at the retailer and via the system. In database access step 616, the system may optionally offer to the retailer access to item information databases and “for sale” databases accessible to the system, for example to induce the retailer to use the system to resell returned and/or refurbished items. The method 600 ends at step 618 until the method begins again at item information receiving step 604.

Referring to FIG. 7, a method for producer partnering is described and generally designated 700. The method 700 begins at item information receiving step 704, in which the system receives standardized item descriptions and other information supplied by the producer, such as photos, item dimensions and weight, and technical specifications of the item. In commission provision step 706, the system provides a commission to the producer each time an item formerly associated with the producer is sold via a site generated by the system. In first authorization step 708, the system may authorize the producer to advise others (e.g., wholesalers, retailers, buyers) of the existence of a site or sites generated by the system and that items purchased from the producer may later be resold via the site or associated sites. In sales data provision step 710, the system may feed back to the producer sales statistics and other information, optionally limited to data regarding items formerly associated with the producer. In second authorization step 712, the system may optionally authorize the producer to include with each item resale-specific identification information, such as resale logos or descriptors, ID codes, or source-identifying marks. In suggestion step 714, the system, producer, buyer, and/or seller may suggest to end customers that the actual cost of any item is the purchase price less eventual resale proceeds, for example in order to induce further sales activity at the producer and via the system. In database access step 716, the system may optionally offer to the producer access to item information databases and “for sale” databases accessible to the system, for example to induce the producer to use the system to resell returned and/or refurbished items. The method 700 ends at step 718 until the method begins again at item information receiving step 704.

### FIRST OPERATIVE EXAMPLE

Embodiments of the invention are described in this and the next two sections of the detailed description by way of operative examples. Embodiments of the invention provide for the management of online resale activity, such as via online auction or fixed price sales sites as has been described in the previous section of the detailed description. The operative examples are sometimes specifically described in the context of items that are easily identified using standardized codes such as the Universal Product Code (UPC). However, embodiments of the invention are applicable to any type of item that may be described and offered for sale, as can be appreciated by those of ordinary skill within the art.

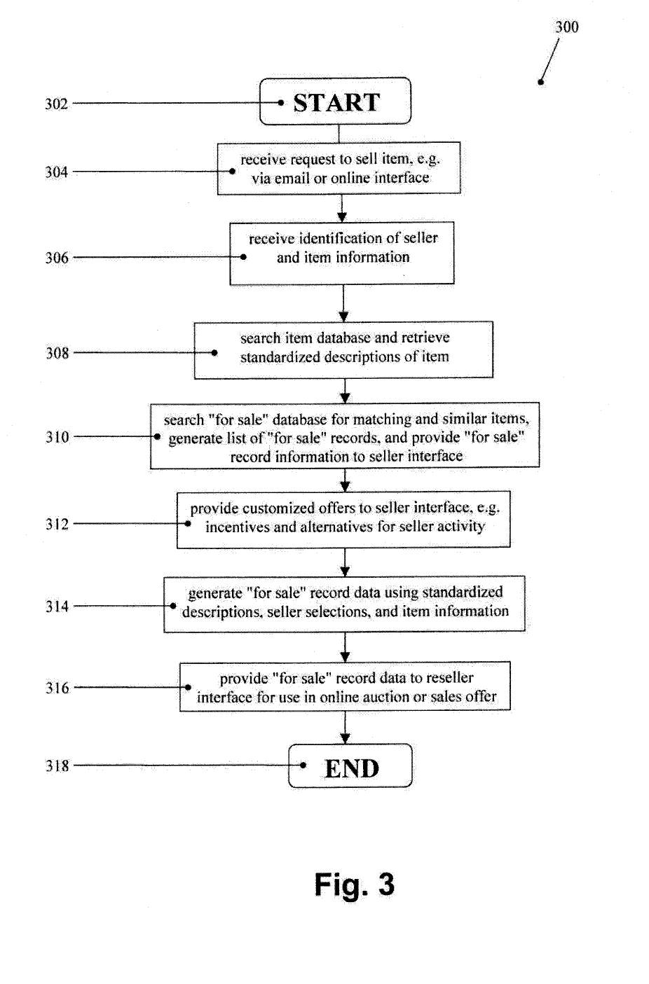

FIG. 3 shows a flow diagram representation of a method 300 of generating a “for sale” record implemented by the system. The method 300 includes a request receiving step 304, an identification receiving step 306, an item search step 308, a “for sale” search step 310, a customized offer step 312, a record generation step 314, and a record provision step 316.

The method 300 begins at step 302 and proceeds to request receiving step 304 in which a web site generated by system 202 may be visited by a seller wishing to sell a particular item. A request to sell an item may be received via an online interface supplied by the web site, via electronic mail, or via other methods and sources of conveying requests well known to one of ordinary skill in the art. Preferably, the seller may use and the web site may receive the request via an online interface.

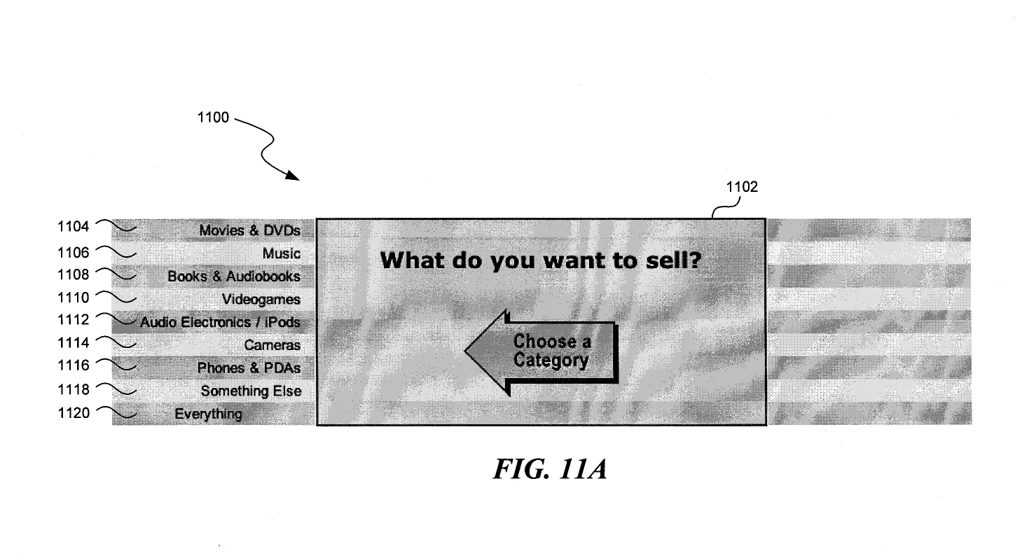

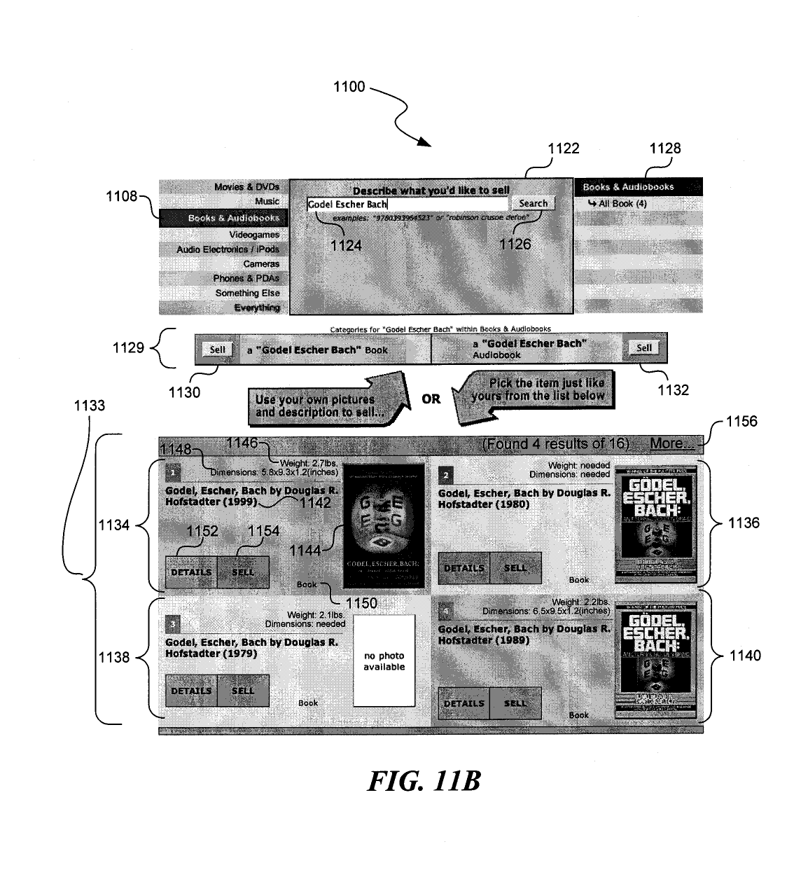

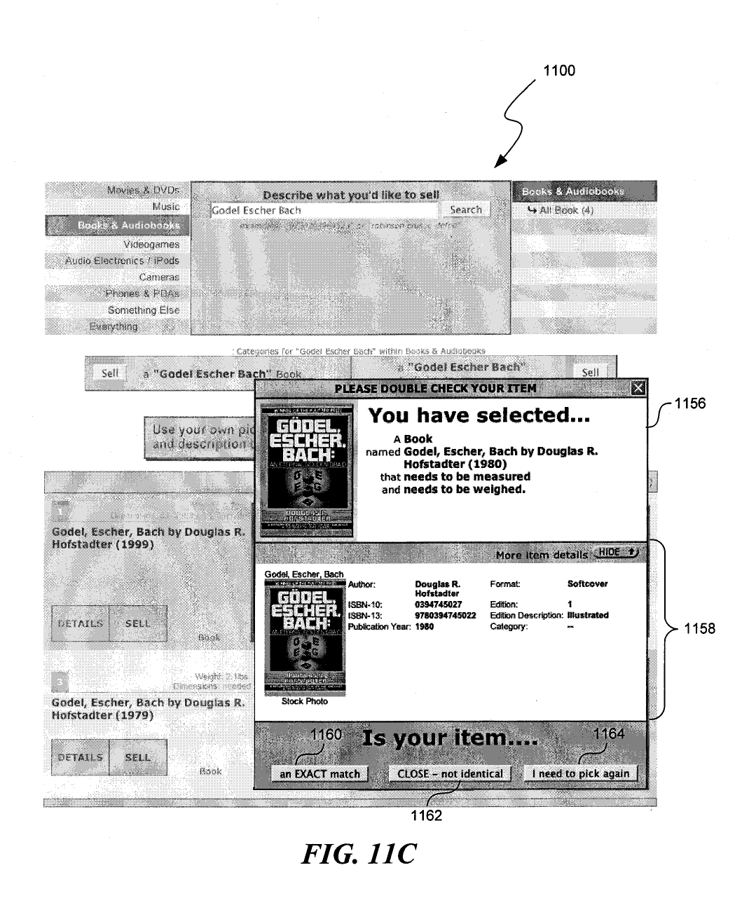

FIG. 11A depicts an online interface 1100 that the system may use to receive requests by sellers wishing to sell items. The interface 1100 includes a region 1102 that indicates to sellers that they should choose a category, shown as categories 1104-20, that corresponds to the item(s) that they wish to sell. These categories 1104-1120 can correspond to pre-defined categories on one or more online resale sites. Category 1104 includes “Movies & DVDs;” category 1106 includes “Music;” category 1108 includes “Books & Audiobooks;” category 1110 includes “Videogames;” category 1112 includes “Audio Electronics/iPods;” category 1114 includes “Cameras;” category 1116 includes “Phones & PDAs;” category 1118 includes “Something Else,” which can include items that may not correspond to one of the other aforementioned categories; and category 1120 includes “Everything,” which can include all (or nearly all) items in all (or nearly all) categories. The system can display other categories in addition to or as an alternative to the aforementioned categories.

FIG. 11B depicts the online interface 1100 after the seller has selected category 1108, “Books & Audiobooks.” Upon receiving this category selection from the seller, the system displays a region 1122 that enables the seller to input an identifier of the item to be listed for sale. The region 1122 includes a text input box 1124 and a search button 1126. The seller may input an identifier of an item, such as a Universal Product Code (UPC) corresponding to the item, an item title, an author, a model number and/or various other descriptors of the item. Alternatively, the seller may identify the item using drill-down menus or other means of description. The seller may also input seller identification information (e.g., login and password, email address, or any other seller identifying information) to facilitate the sale of the item. The seller identification information may be stored in an account associated with the seller. The interface 1100 as depicted in FIG. 11B can perform the identification receiving step 306 of the method 300 of FIG. 3. Alternatively, the interface 1100 depicted in FIG. 11B can receive information related to the item and the system may allow the seller to input seller identification information at a later stage in the item listing process, such as after the seller has provided most or all of the item information.

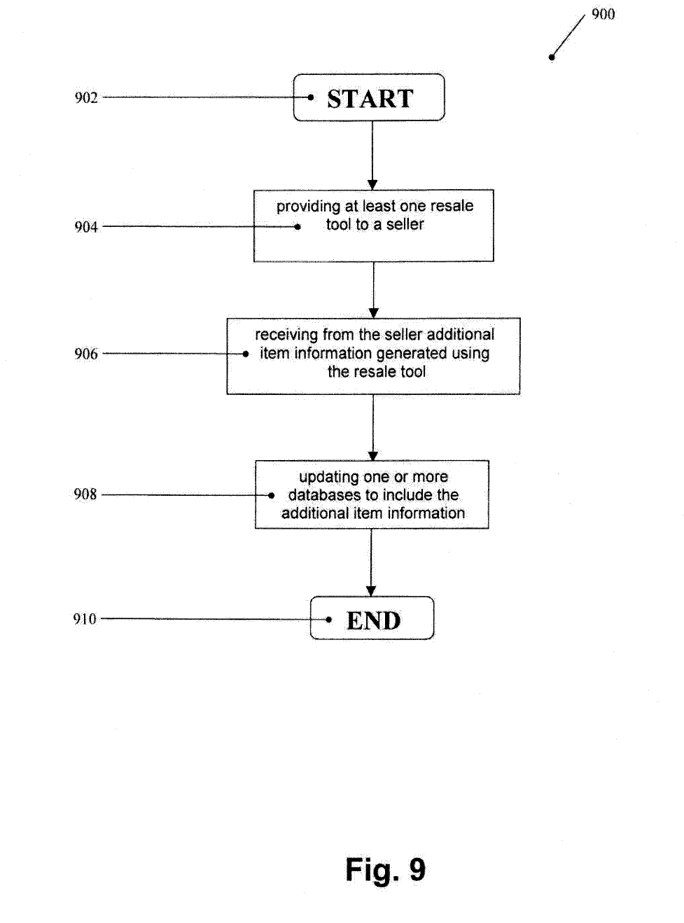

In alternate embodiments, the seller may utilize system-provided resale tools to add additional item information. In an exemplary embodiment illustrated in FIG. 9, a method 900 is provided which includes a providing step 904, a receiving step 906, and an updating step 908. The method 900 begins at 902 and proceeds to the providing step 904 including providing at least one resale tool (e.g., software) to a seller. For example, the system may provide a web-based software tool enabling a user to create images and/or add information to an existing image of an item offered for sale, including highlighting or drawing attention to specific images or portions of an image and/or textual information describing characteristics (e.g., upgrades, add-ons, flaws, blemishes, etc.) of or associated with the offered item. A person of ordinary skill in the art would immediately appreciate that a web-based software tool is not required, and a wide variety of tool variations may be employed without departing from the spirit or scope of the invention, including but not limited to other tools formed using software and/or hardware, web-based or otherwise, relating to graphical, textual, descriptive, accessory, complementary, or other properties of an item or group of items. Of course, the same or similar tools may be made available to buyers, retailers, producers, third party providers, one or more systems, or others to facilitate resale activity in a like manner as should be apparent to those of ordinary skill in the art.

The method 900 proceeds to the receiving step 906 including receiving from the seller the additional item information generated using the resale tool. For example, the system may receive from the seller additional images, textual information, and/or associated highlighting describing characteristics of the particular item offered for sale and/or of the class of products of which the item is a member.

The method 900 proceeds to the updating step 908 including updating one or more databases including item information and/or “for sale” records to include the additional item information. The method 900 ends at step 910 until the same or another tool is provided at providing step 904. In this way, the system, seller, or others may emphasize quality, attention to detail, accuracy, or other factors relevant to a resale transaction, thus inducing trust and facilitating additional resale activity.

Referring again to FIG. 3, the method 300 proceeds to item search step 308, in which the system may command or implement a search of databases that include item information. The system can include one or more databases that it searches or the system may search one or more databases that are provided by another party (e.g., a retailer, distributor, manufacturer and/or data agglomerator, etc). The system can retrieve information on matching and/or similar items, such as item pictures, item descriptions, item prices and/or other information from the database(s). The method 300 may also proceed to “for sale” search step 310, in which the system may command or implement a search of one or more databases that include items offered for sale, up for auction, previously sold, previously auctioned, and/or any other sales or item information germane and/or available. The results of both the item search and the “for sale” search may be presented to the seller for consideration prior to the seller finally committing to offer its item for sale. Referring again to FIG. 11B, the interface 1100 includes several regions that can depict the results of either or both of the searches performed in steps 308 and 310 of FIG. 3. In the interface 1100 depicted, the search was for “Godel Escher Bach” in the “Books & Audiobooks” category 1108. Region 1128 depicts the results of the search (four books found by the system) confined to results in this category. The system may use exact matching algorithms, fuzzy matching algorithms and/or other matching algorithms in the search to account for variations and inaccuracies in spelling and text entry.

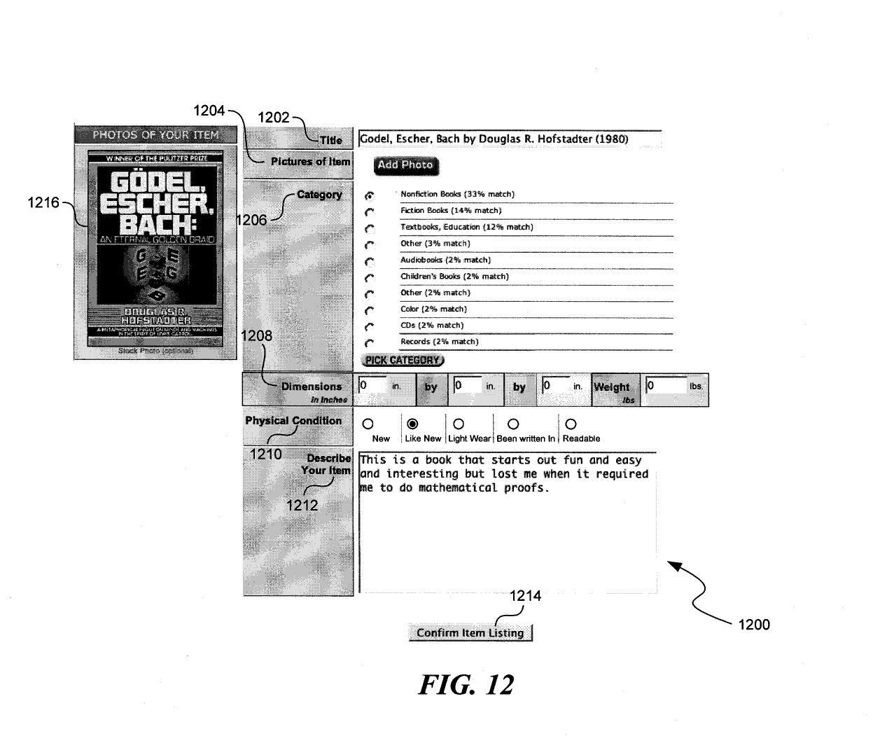

The system presents the seller with a number of different options to allow the seller to easily create a “for sale” listing in order to sell an item. A first region 1129 contains two options that allow a seller to manually create “for sale” listings by providing many of the details necessary to populate a listing. If the seller selects button 1130 or button 1132 within the first region 1129, the system can present an interface, such as the interface depicted in FIG. 12, that allows the seller to provide their own pictures, description, and/or other aspects of the item to the system in order to generate the “for sale” listing. A second region 1133 contains options that allow a seller to automatically create a “for sale” listing using a template, pre-populated form, or other standardized description to provide many of the details for the listing. The seller may use the standard description without modifications or may add additional pictures, descriptive text and/or other information. The second region 1133 depicts one or more potential matching candidates 1134-1140 that may correspond to the item the seller wishes to sell. Each candidate contains information that allows the seller to ascertain if the candidate corresponds to the item to be listed for sale. For example, candidate 1134 identifies the item as a book 1150 and includes a book title, author and publication date 1142. The candidate 1134 also includes a picture 1144 that can further enable the seller to identify the item. If the seller requires more information, the seller can click on button 1152 to obtain further details about the item. The candidate 1134 also includes an item weight 1146 and item dimensions 1148 that can be retrieved from one of the system's databases that includes item information or an external database of item information. If the seller decides that this candidate corresponds to the item that he or she wishes to sell, the seller can select it by clicking on button 1154. If the seller cannot find the item matching the one that they would like to sell, the seller can select a “More” button 1156 to see additional candidates identified by the system.

After selecting a candidate that matches the item the seller would like to sell, the system can require the seller to confirm their selection. The system can do so by displaying a dialog box requesting confirmation of the selection. In FIG. 11C, the interface 1100 displays such a confirmation request in the dialog box 1156 that shows additional information about the item corresponding to the selected candidate 1136 in FIG. 11B. The dialog box 1156 can include details about the item, such as the item picture, title, author, etc. The dialog box 1156 can also include a region 1158 that displays additional item details, such as the ISBN number, the format, and the edition number. The dialog box 1156 also includes three buttons 1160-1164 that the seller can select if the item is an exact match, a close match, or not a match at all, respectively. The system may also use other schemes for selecting levels of matching using more choices represented by other buttons (not shown). If the seller selects button 1164 the system can re-display the interface 1100 as depicted in FIG. 11B to permit the seller to make another selection of a candidate or to input a different item identifier altogether to search for a different candidate. If the seller selects button 1162 the system can display another interface that permits the seller to revise the item details. That is, the system may allow the user to change one or more of the details in the item description in order to better conform the description to the item that is to be sold. If the item description selected exactly matches the seller's item, the seller can select button 1160.

FIG. 12 depicts an online interface 1200 that allows the seller to add additional item-specific information to the “for sale” listing or to revise the information retrieved from one of the databases of item information. The system can display the interface 1200 in response to the seller's selection of the button 1160 or the button 1162 of FIG. 11C, or in response to the seller's selection of the buttons 1130 or 1132 of FIG. 11B. The interface 1200 includes a title region 1202 that allows the seller to edit the item title. Region 1204 allows the seller to add a photo of the item that can be displayed in addition to the photo 1216 retrieved from a database of item information. The seller can, for example, add an actual photo of the item he or she desires to sell that can be displayed in conjunction with the photo 1216. Category region 1206 depicts various categories, or sub-categories of the Books & Audiobooks category 1108 of FIG. 11A, that can correspond to sales categories on online auction or fixed-price retail web sites. The seller can select a category or the system can choose a category for the seller based upon various factors. In region 1208, the seller can input the dimensions of the items (in inches or in any other format, e.g., centimeters) as well as the item weight (in pounds or in any other format, e.g., kilograms). The seller can select a physical condition that describes the item's physical condition using a series of radio buttons in region 1210. In region 1212 the seller can add a description of the item that can supplement the item description taken from the database of item information. In some embodiments, the system does not display certain regions of the interface 1200 if the system has retrieved data associated with these regions that the system determines should not be edited by the seller. For example, if the system retrieves the item dimensions and/or the item weight from one of the databases of item information, the system may determine that the seller should not be able to edit the item dimensions and/or the item weight and thus that they should not be displayed. Alternatively, the system may still display the item dimensions and/or the item weight as text or figures that may or may not be editable. For certain items, if the system cannot retrieve dimensions and/or weight for a particular item from one of the databases of item information, the system may provide likely or probable item dimensions and/or item weight. For example, items such as DVDs or music CDs typically have standardized dimensions and weights. If the seller desires to sell a particular DVD and the system cannot retrieve its particular dimensions and/or weight from a database, the system can still provide the standardized dimensions and/or weight for DVDs. In such a scenario, the system may indicate that the standardized dimensions and/or weight are an estimate and may allow the seller to override the standardized dimensions and/or weight by editing these aspects. The interface 1200 can also include other regions (not shown) that allow the seller to specify additional item details, such as an item price, seller information, shipping information, etc. If the “for sale” listing is for an online auction site, the interface 1200 can also allow the seller to specify aspects of the listing related to auctions, such as the type and/or format of the listing, auction start and end dates, minimum bid, bid size, reserve price, etc. Alternatively, the system can provide additional interfaces (not shown) subsequent to the interface 1200 that allow the user to provide or choose the auction-related aspects of the listing. Once the seller has added additional information to the “for sale” listing, the seller may confirm that the item should be listed by selecting button 1214. The use of a template that is pre-populated with information about an item greatly increases the speed and accuracy with which a seller may post items for sale.

Returning again to FIG. 3, in customized offer step 312 the system may provide incentives to the seller to induce additional sales activity, for example the seller may be offered reduced fees for referring additional sellers. The system may provide alternatives to the seller, for example the system may propose alternative online auction sites and/or online fixed price sales sites at which the seller may list its item for varying fees. Of course, it should be recognized that the invention is not limited to the specific incentives and alternatives listed above, and may include a wide variety of incentives and alternatives as are well known to those of ordinary skill in the art.

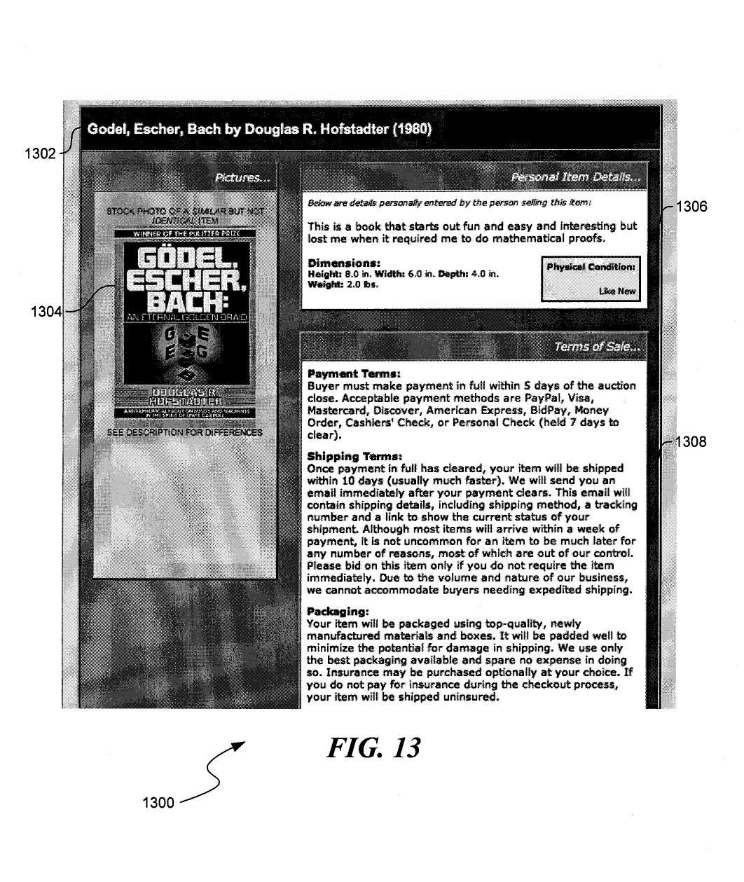

After the seller provides information relevant to the individual item desired to be sold, the method proceeds to record generation step 314, in which the system generates “for sale” record data for use with one or more online auction or fixed-price web sites. FIG. 13 depicts an exemplary “for sale” listing 1300 that may be used with one or more online auction and/or fixed-price web sites. The listing 1300 includes a title 1302 that can correspond to the title for the item retrieved from a database of item information, as modified by the user. The listing 1300 also includes an item photo 1304 and can include any other photos added by the seller. Region 1306 can include a description of the item. The item description can include the description retrieved from one of the databases of item information, as modified or supplemented by the additional description provided by the seller. Region 1306 can also include the item condition and the item dimensions and weight. Region 1308 includes terms of sale, including payment and shipping terms and information about item packaging. The listing 1300 can also include other item information (not shown), including, but not limited to: an item price, seller information, shipping information, etc. If the item is sold on an online auction website, the other item information can also include aspects of the item related to auctions, such as the auction start and end dates, minimum bid, bid size, etc. In some embodiments, the system displays the listing 1300 to the seller before submitting it to the online auction and/or fixed-price web sites. The seller thus has the opportunity to review the listing 1300 (including the data obtained from the databases of item information and the seller-provided information) and confirm that it is correct. If it is not, the system can allow the seller to modify aspects of the listing 1300. This can be done by allowing the seller to directly edit aspects of the listing 1300 or by providing a button (not shown), that when clicked on, takes the seller back to the interface 1200 depicted in FIG. 12.

Returning to FIG. 3, in record provision step 316, the system may provide the “for sale” record data to one or more online auction web sites, fixed-price web sites, or other reseller channels known in the art. In some embodiments, the system provides the “for sale” record data to a pre-determined set of one or more online auction web sites, fixed-price web sites and/or reseller channels. The system may provide the “for sale” record data to sites based upon various factors, including the likelihoods that the item will sell on the sites, site listing fees or commissions, affiliation with other items on sites, if the item is part of a site group or promotion and/or other considerations. In some embodiments, the system allows the seller to choose one or more online auction web sites, fixed-price web sites, or other reseller channels to provide the “for sale” record data. The system may suggest one or more of these sites to the seller based upon the above-mentioned factors and considerations. If the seller does not specify that all sites should be provided with the “for sale” record data to, the system may allow the seller to later add the omitted sites. The system may also allow the seller to remove the “for sale” record data from sites to which the “for sale” record data has been provided.

In some embodiments, record provision step 316 may include providing “for sale” record data in various formats and contexts instead of, in combination with, or prior to providing such data to online auction web sites. For example, record provision step 316 may include implementation of an auction “preview” in which provision to an online auction web site is delayed for a specific period of time (e.g., three days) during which the system may exclusively offer one or more items associated with the “for sale” record data on a proprietary site. In such alternate embodiments, information received from the seller may include a “preview” price point above which the seller may be willing to complete a resale transaction (e.g., forego an auction), and/or the information received from the seller may include a solicitation for one or more “best offers” from “preview” buyers (e.g., buyers selected for and/or participating in a “preview” of a planned future auction or fixed-price offer).

In some embodiments, the system provides the “for sale” record data to one or more online auction web sites, fixed-price web sites, or other reseller channels to be listed for sale on behalf of the seller under one or more operator accounts associated with the system or system operator, i.e., under an account that is not associated with the seller. In these embodiments, the items listed for sale by the system can appear to be for sale by the accounts associated with the system or system operator, which essentially aggregates the “for-sale” listings of one or more sellers. However, an operator of the system does not actually need to take physical possession of the items, which remain with the sellers of the items. The system may indicate to potential buyers that its operator accounts are not the actual sellers and/or shippers of the listed items. The system may indicate that it provides a guarantee, such as a money-back refund, to assure buyers that that the actual sellers will ship the actual items. The system may also indicate in other ways who the actual sellers of the items are, such as by dividing out the sellers on a feedback page. In some embodiments, the system provides the “for sale” record data to one or more online auction web sites, fixed-price web sites, or other reseller channels to be listed under the account associated with the actual seller of the item listed for sale. In these embodiments, sellers list items for sale under their own accounts but benefit from the consistent and functional coordination of post-sales activity provided by the system's techniques. In these embodiments, the system may indicate to potential buyers that the listing was prepared in accordance with the system's techniques, such as by displaying a logo, slogan or tagline associated with the system's operator.

The method 300 ends at step 318 until the same or another seller chooses to begin the method 300 again.

### SECOND OPERATIVE EXAMPLE

In this section of the detailed description, a second operative example is described. As with the previous operative example, the second operative example is sometimes specifically described in the context of items that are easily identified using standardized codes such as the Universal Product Code (UPC). However, the invention itself is not so limited. That is, embodiments of the invention are applicable to any type of item that may be described and offered for sale, as can be appreciated by those of ordinary skill within the art.

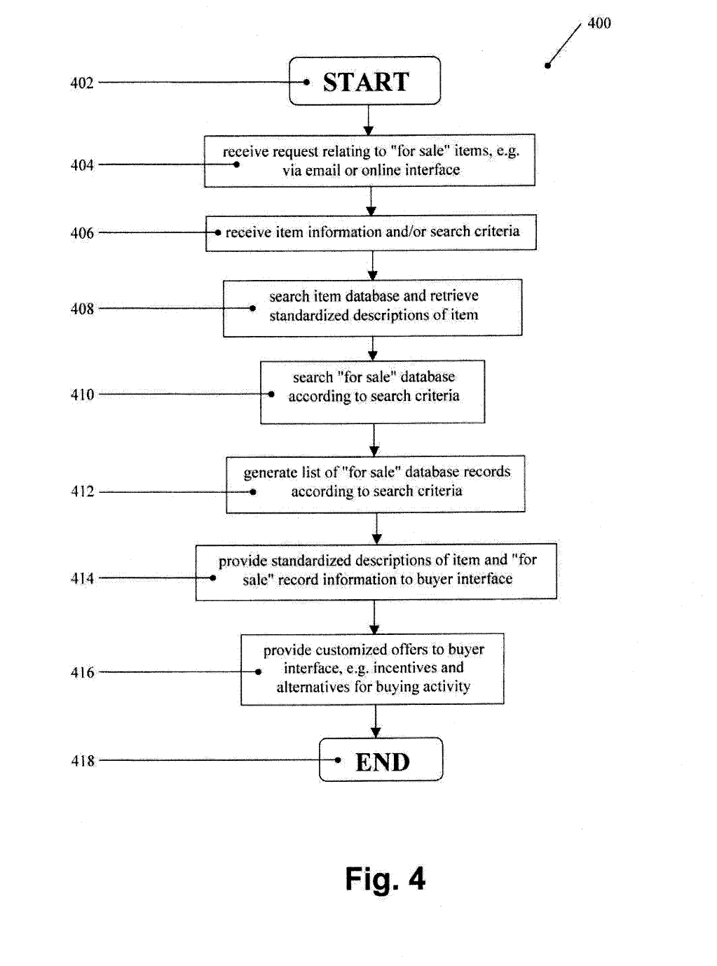

FIG. 4 shows a flow diagram representation of a method of providing “for sale” record information for use by prospective buyers generally designated 400. The method 400 includes a request receiving step 404, an item description receiving step 406, an item search step 408, a “for sale” search step 410, a list generation step 412, a record provision step 414, and a customized offer step 416.

The method 400 begins at step 402 and proceeds to request receiving step 404 in which the system may receive a request relating to “for sale” items. The request may be received via an online interface supplied by the system, via electronic mail, or via other methods and sources of conveying requests well known to one of ordinary skill in the art. Preferably, a prospective buyer may use and the system may receive the request via an online interface.

The method 400 proceeds to item description receiving step 406, in which the prospective buyer may input item identification information, such as a Universal Product Code (UPC) corresponding to the item. Alternatively, the prospective buyer may identify the item using drill-down menus or other means of description. The prospective buyer may also input search criteria to narrow the list of items to those meeting specified preferences such as mileage or condition.

The method 400 then proceeds to item search step 408, in which the system may command or implement a search of databases including item information and retrieve standardized descriptions of matching and/or similar items. The method 400 may also proceed to “for sale” search step 410, in which the system may command or implement a search of databases including items offered for sale, up for auction, previously sold, previously auctioned, and/or any other sales or item information germane and/or available. The system may generate lists of database records according to the input search criteria in list generation step 412. In record provision step 414, the results of both the item search and the “for sale” search may be presented to the prospective buyer for consideration prior to the prospective buyer finally committing to any particularly buying activity.

In customized offer step 416, the system may provide incentives to the prospective buyer to induce additional sales activity, for example the prospective buyer may be offered reduced fees for referring additional buyers and/or sellers. The system may provide alternatives to the prospective buyer, for example the system may propose alternative online auction sites and/or online fixed price sales sites at which the prospective buyer may find the same or similar items at various asking prices. Of course, it should be recognized that the invention is not limited to the specific incentives and alternatives listed above, and may include a wide variety of incentives and alternatives as are well known to those of ordinary skill in the art.

The method 400 ends at step 418 until the same or another prospective buyer chooses to begin the method 400 again.

### THIRD OPERATIVE EXAMPLE

The previous two sections of the detailed description described pre-sale seller-related interaction and pre-sale buyer-related interaction with the system, respectively. By comparison, in this section of the detailed description, post-sale activity is described. As with the previous operative examples, the third operative example is sometimes specifically described in the context of items that are easily identified using standardized codes such as the Universal Product Code (UPC). However, the invention itself is not so limited. That is, embodiments of the invention are applicable to any type of item that may be described and offered for sale, as can be appreciated by those of ordinary skill within the art.

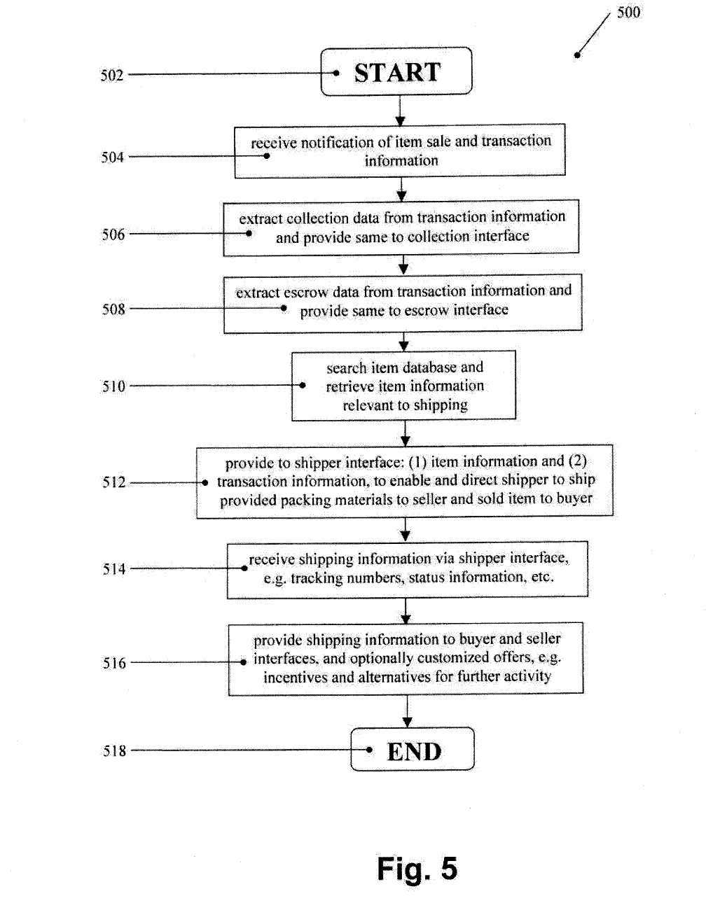

FIG. 5 shows a flow diagram representation of a method of post-sale coordination generally designated 500. The method 500 includes a sale notification step 504, a collection step 506, an escrow step 508, an item search step 510, a shipper provision step 512, a shipping information receiving step 514, and a buyer/seller notification step 516.

The method 500 begins at step 502 and proceeds to sale notification step 504 in which the system 202 may receive notification that a buyer has agreed to purchase an item previously listed “for sale” on behalf of a seller. The notification may be received via an online interface supplied by the system, via electronic mail, or via other methods and sources of conveying notifications well known to one of ordinary skill in the art. Preferably, the system may receive the notification via electronic mail, including detailed transaction information, for example agreed sales price, buyer and seller identification information, item information, etc.

The method 500 proceeds to collection step 506, in which the system may provide selected transaction information to a collection interface. For example, the system may send a request for payment to the buyer, including the agreed sale price, item identification information, and instructions for submitting payment. In escrow step 508, escrow data extracted from the transaction information may be used to command or implement placing of funds received from the buyer into an escrow account to be released to the seller only upon item delivery and/or conclusion of the sales transaction.

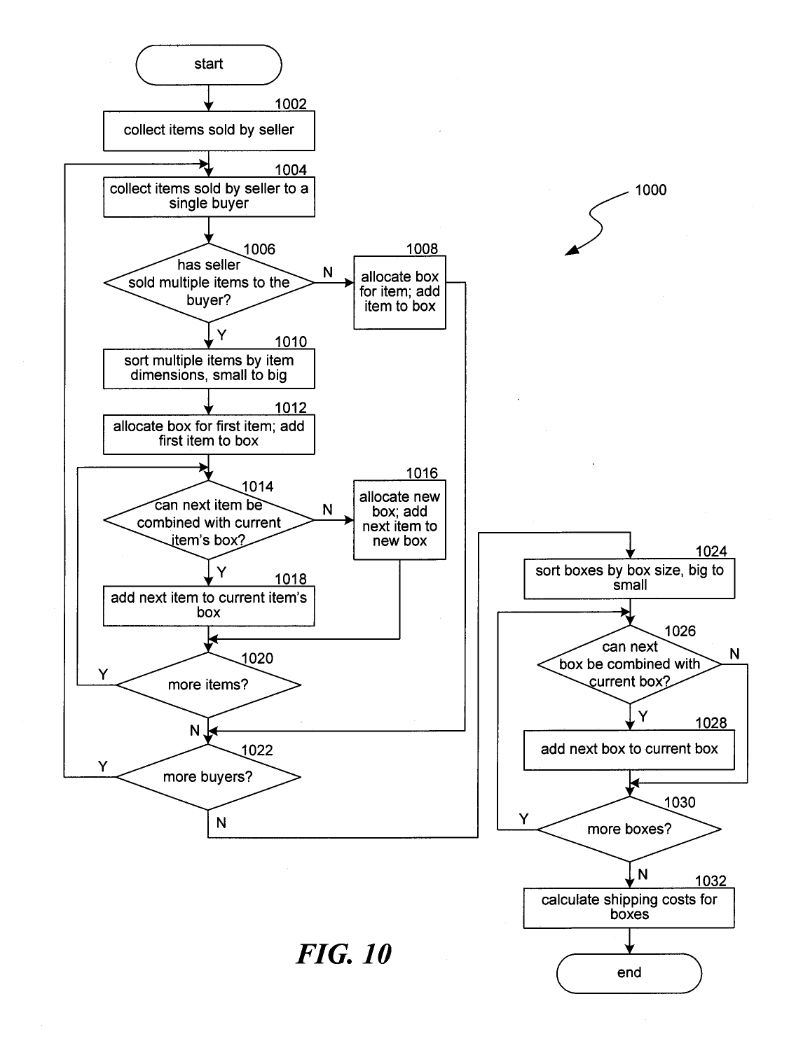

The method 500 then proceeds to item search step 510, in which the system may command or implement a search of databases including item information and retrieve standardized descriptions of the item relevant to shipping considerations, such as dimensions and weight of the item, fragility characteristics of the item, customary shipping container characteristics, etc. As described in further detail with respect to FIG. 10, the system can use at least the item dimensions and weight to determine the proper shipping materials to be sent to the seller.

The method 500 may then proceed to shipper provision step 512, in which the system may command or implement communication to the shipper (e.g., shipper 204 shown and described above with reference to FIG. 2) of item information retrieved in item search step 510 and selected transaction information received in sale notification step 504. The system may communicate with the shipper to ease transport and/or shipping of the sold item from the seller to the buyer. Toward that end, the system may command or implement communication to the shipper of pre-addressed shipping labels in electronic or hard-copy form, for shipping of packaging materials to the seller and for shipping of the sold items from the seller to the buyer. The system may command or implement shipping of the packaging materials directly to the seller, including a box or other external enclosure, packing materials such as foam peanuts or airpacks, and order information documents such as bills of lading, etc.

In some embodiments, the system commands or implements shipping of the packaging materials to a seller according to a method 1000 illustrated in FIG. 10. Turning to this figure, the method 1000 begins at step 1002 in which the system identifies all items sold by a seller. In some embodiments, the system identifies only those items which have been paid for by buyers. Alternatively, the system identifies all sold items, regardless of paid status. The system can also identify items which have not yet sold but which are likely to sell, as determined by the system according to a heuristic algorithm or other method, in order to increase the likelihood of batching together either multiple items from one seller to one buyer or multiple empty boxes to one seller. The system may do this in order to reduce shipping costs applicable to both the shipment from the system to the seller and from the seller to the buyer. In step 1004 the system identifies a single buyer and identifies all items that were sold by the seller to the single buyer (e.g., a unique buyer, or multiple buyers at a unique address). In step 1006 the system determines whether the seller has sold multiple items to the single buyer. If not, in step 1008 the system allocates a box for the item sold to the single buyer, adds the item to the box, and the method 1000 continues at step 1022. In this context, allocating a box for an item and adding the item to the box does not refer to physically placing the item in the box. Rather, it refers to the allocation of a properly-sized box for the item, as determined by the system, based at least partially upon dimensions and weight for the item that the system has retrieved from one of the databases of item information. Alternatively, if the seller has provided item dimensions and weight, the system can base the allocation at least partially upon the seller-provided information. This allocation can also take into account any necessary packing materials, shipping rates, and/or other factors. The dimensions and weight of the item and other unique shipping characteristics about the item may be stored in the database that maintains product information about the item and accessed by the system, or the dimensions and weight of the item and any other unique shipping characteristics may be provided by the seller to the system. The system may also maintain a database that stores information about available boxes, such as sizes, weights, volumes, etc. and of available packing materials. For example, the database may store information about the appropriate box and packing materials for a single DVD (e.g., a padded flat mailer) or a set of DVDs (e.g., box with packing peanuts). Alternatively or additionally, the database may store information used by the system to calculate the appropriate box for an item. For example, new DVDs, especially sets of multiple DVDs, may be packaged in a variety of enclosures that vary in size and/or in weight. If a seller is shipping a set of multiple DVDs to a buyer, the system may not be able to obtain the correct dimensions and weight for the set of multiple DVDs in order to calculate the appropriate box. Nonetheless, the system may maintain information about the various enclosures in a database that allows the system to determine the largest possible enclosure that can still be packaged and shipped in a box that qualifies for a particular shipping method (e.g., media mail through the United States Postal Service (USPS)). The system may use curve-fitting to determine the appropriate box(es) for one or more items.

The term “box” includes a box as commonly known as well as a carton, shipping tube, envelope, enclosure, or any other item that can be used to package or enclose items for shipping, transport and/or delivery. If at step 1006 it is determined that the seller has sold multiple items to the single buyer, then the method 1000 continues in step 1010, in which the system sorts the multiple items by item dimensions, from the smallest item to the biggest item. In step 1012, beginning with the smallest item, the system allocates a properly-sized box for the first of the multiple items and adds the first item to the box. In step 1014 the system determines whether the next item can be added to the current item's box. This refers to whether the next item can be included in the box for the current item. If necessary, the system enlarges the box for the current item, such as by increasing one or more of its dimensions, up to a pre-determined maximum or threshold size. In some embodiments, this pre-determined maximum or threshold size is based at least partially upon shipping costs, such as shipping costs for boxes larger than the pre-determined maximum or threshold size. For example, the USPS may allow boxes up to a certain size (e.g., 24 inches by 36 inches by 24 inches) to be shipped via media mail, but boxes that are larger than that certain size may not be shipped via media mail. In some embodiments, the system determines the maximum or threshold size of the box taking into account the weight of all included items, packing materials and boxes. If the system determines that the next item cannot be added to the current item's box without exceeding this pre-determined maximum or threshold size, the method 1000 continues in step 1016, where the system allocates a new box for the next item and adds the next item to the new box. If the next item can be added to the current item's box, the method 1000 continues in step 1018, in which the system adds the next item to the current item's box. In either case, the method 1000 continues in step 1020, in which the system determines whether there are more items. If so, then the method 1000 returns to step 1014. If not, then the method 1000 moves to step 1022, in which the system determines whether there are more buyers to whom the seller has sold items. If so, the method returns to step 1004 and completes the box selection methodology for items that are going to be shipped to another buyer.

If the system determines that there are no more bought items for that seller, the system attempts to combine boxes previously allocated for purchases by buyers into as few shipments as possible. The method 1000 continues in step 1024, in which the system sorts the previously allocated boxes by box size, from the biggest box to the smallest box. Beginning with the biggest box, in step 1026, the system determines whether the next box can be combined with the current box. This refers to determining whether the next box can be placed inside the current box, if necessary enlarging the box by enlarging one or more of its dimensions, up to a pre-determined maximum or threshold size, as previously described. If the next box cannot be placed inside the current box, the method continues at step 1030. If the next box can be combined with the current box, the method 1000 moves to step 1028, in which the system adds the next box to the current box. The method continues in step 1030, in which the system determines whether there are more boxes. If so, the method 1000 continues in step 1026. If not, the method moves to step 1032

In step 1032 the system calculates the cost of shipping all boxes that are not contained in another box to the seller. In this step, the system calculates the shipping costs taking into account each box's weight, the weight of any packing materials, the weight of any included boxes and their respective packing materials, the seller's address, and/or any other factors. The system can also calculate the cost that the seller would have to pay in order to ship each box to each buyer once the item or items have been placed inside each box, based upon each box's weight, the weight of its packing materials and the item or items contained within the box, the buyer's address and/or any other factors. The system can determine shipping costs from the shipper based upon the size of the boxes, the weight of the boxes, the desired shipping speed (e.g., overnight, 2-day, ground, media mail), the seller/buyer's address and/or other factors. The system can obtain shipping costs for the appropriate boxes from a single shipper or from multiple shippers. The system can perform this step in real time for each appropriate box by providing the shipper with the necessary information (e.g., box dimensions, box weight, and/or desired shipping method) and obtaining from the shipper an estimate or cost of shipping the box. The system can then determine the appropriate shipper (if it has queried multiple shippers) as well as the appropriate shipping method, which may or may not be the lowest-cost shipping method. For example, the system may determine that the appropriate shipping method is USPS media mail, because it is the cheapest method of shipping the boxes. As another example, the system may determine that the appropriate shipping method is United Parcel Service (UPS) ground due to a requirement of the seller or the buyer. The system can perform this step using techniques that are well-known in the art, such as by interacting with the shipping APIs provided by UPS or the USPS via their respective websites.

Returning to step 512 of FIG. 5, in some embodiments, the system may provide packing materials (e.g., shipping labels, shipping instructions and/or information, boxes, padding, etc.) to the shipper in addition to instructions to enable and direct the shipper to ship the provided packing materials to the seller for ease or transporting the sold item to the buyer. The shipping instructions may include, for example, instructions for the seller on how to ship each item that the seller has sold to the appropriate buyer. It should be apparent that the shipper may or may not include and/or function as a fulfillment entity that receives orders, prints shipping labels, assembles containers, boxes, and other cartons for shipping/transport to the seller. Alternatively or in addition to the above, the system may perform shipper provision step 512 in support of sellers, buyers, and/or other end users for which no online auction or other sales activity has been performed or contemplated in conjunction with the system. For example, the system may provide a separate site or interface for this purpose to selected sellers, buyers, or the public at large. For another example, the system may provide an application programming interface (API), compatible software, or other mechanism to any retailer, producer, seller, shipper, or other participant in online commerce, to allow simple integration of a shipping interface with other software.

The method 500 then may proceed to shipping information receiving step 514, in which the shipper may provide to the system tracking, tracing, and/or status information related to packages in transit. The tracking, tracing, and status information may include tracking numbers and codes for monitoring the progress of the packaging materials to the seller, as well as the progress of the sold item between the seller and the buyer. It should be appreciated that the shipper may aggregate packing materials, boxes, and order documents for volume sellers to avoid duplicate shipping charges from shipper to seller.

In buyer/seller notification step 516, the system may provide the tracking, tracing, and status information previously received from the shipper. In addition, the system may offer incentives to the seller and/or buyer to induce additional sales activity, for example the seller and/or buyer may be offered reduced fees for referring additional buyers and/or sellers. The system may provide alternatives to the seller and/or buyer, for example the system may propose alternative online auction sites and/or online fixed price sales sites at which similar items are offered at various asking prices. Of course, it should be recognized that the invention is not limited to the specific incentives and alternatives listed above, and may include a wide variety of incentives and alternatives as are well known to those of ordinary skill in the art.

The method 500 ends at step 518 until another sales notification is received at sale notification step 504 to begin the method 500 again.

One advantage of the system is that by implementing the methods described in FIGS. 5 and 10, the system can provide the requisite materials (including boxes, packing materials, shipping labels, shipping instructions, etc.) to sellers to allow them to ship items to buyers, thus facilitating the delivery process. The system provides a consistent approach to post-sale logistics that is suitable for use by a wide variety of sellers, especially “casual” sellers who may lack selling resources, infrastructure and/or expertise. Another advantage is that by aggregating multiple boxes to be sent to a seller, and by aggregating multiple boxes to be sent from a seller to a buyer, the system can reduce various expenses, including shipping and handling costs. A system operator can thus realize significant economies of scale with respect to these reduced expenses. Another advantage of the system is that the system can be provided with the address of a seller, the address(es) of one or more buyers, nearly any item or set of items, and determine the appropriate method of shipping (which likely is the cheapest method, but not necessarily) the necessary box(es) to the seller for shipment of the item(s) to the buyer. This functionality can be used by system operators or can be provided to other parties via an API, compatible software, or other mechanism.

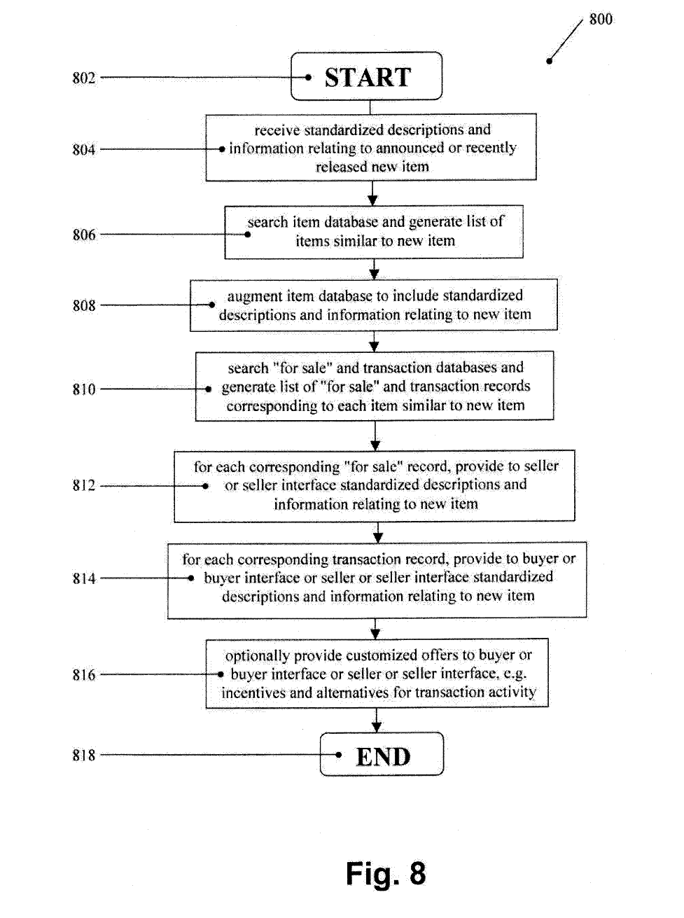

FIG. 8 illustrates another aspect of the invention related to recently-developed items, improved items, or follow-on items related to or similar to items previously sold via the system. In this embodiment, when a new item is released or made available for sale that is related to the previously-sold item, both the seller and buyer may be notified of new item details, such as technical specifications and improvements over the previously-sold item, and/or offered incentives to do business through the system again.

Referring to FIG. 8, a method of informing users of new item offers is illustrated and generally designated 800. The method 800 includes new item description receiving step 804, item search step 806, database augmentation step 808, “for sale” search step 810, first provision step 812, second provision step 814, and customized offer step 816. The method 800 proceeds according to means and modes similar to those described above with reference to FIGS. 3-5, as should immediately be understood by those of ordinary skill in the art.

Embodiments of the invention described above include consistent and functional coordination of post-sales activity, relieving sellers and buyers of associated difficulties. Several method embodiments may be implemented using a simplified interface for use by a wide variety of sellers and buyers. In addition, significant economies of scale (e.g., in shipping) provide improved service for a reasonable cost. One advantage of some embodiments is that the system can facilitate “for sale” listings of items on various sites and provide a guarantee of the items listed for sale, but without taking physical possession of the items.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

I/We claim:

1. A method in a computing system of facilitating the resale of items via one or more network sites, the method comprising:
receiving an indication of an item to be listed for sale from a seller;
searching a data store to identify one or more stored item descriptions that pertain to the received item indication;
displaying the identified one or more stored item descriptions to the seller;
receiving a selection from the seller of a desired item description from the displayed item descriptions;
generating, based at least in part upon the desired item description, a for-sale listing of the item, wherein the for-sale listing comprises an item description and an item picture; and
distributing the generated for-sale listing to at least one third-party network site on behalf of the seller;
receiving a confirmation of the for-sale listing from the at least one network site; and
when the item associated with the for-sale listing is sold to a buyer, notifying the seller of the sale of the item.

2. The method of claim 1, wherein the at least one network site includes an online auction website.

3. The method of claim 1, wherein the at least one network site includes an online fixed price website.

4. The method of claim 1, wherein the indication of an item includes one of a UPC, an ISBN or an EAN.

5. The method of claim 1, wherein the indication of an item is a title of the item.

6. The method of claim 1, further comprising receiving additional information about the item from the seller.

7. The method of claim 6, wherein the additional information is a desired item price and the for-sale listing further comprises the item price.

8. The method of claim 6, wherein the additional information is a seller description of the item and the for-sale listing further comprises the seller description.

9. The method of claim 6, wherein the additional information is a seller picture of the item and the for-sale listing further comprises the seller picture.

10. The method of claim 1, further comprising:
receiving funds from the buyer to pay for the item;
holding the funds in escrow;
instructing the seller to ship the item to the buyer; and
when the buyer has received the item, releasing at least a portion of the funds to the seller.

11. The method of claim 1, further comprising providing packaging materials to the seller for shipment of the item to the buyer.

12. The method of claim 1, wherein the for-sale listing is listed on the at least one network site under an account that is not associated with the seller.

13. A system for facilitating the resale of items via one or more network sites, the system comprising:
a search component that receives an indication of an item to be listed for sale from a seller and searches a data store to identify and display one or more stored item descriptions that pertain to the received item indication;
a listing generation component that receives from the seller a selection of a desired item description from the displayed item descriptions and generates, based at least in part upon the desired item description, a for-sale listing of the item, wherein the for-sale listing comprises an item description and an item picture;
a distribution component that provides the for-sale listing to at least one third-party network site on behalf of the seller; and
a sales management component that, when the item associated with the for-sale listing is sold to a buyer, notifies the seller of the sale of the item.

14. The system of claim 13, wherein the at least one resale host includes an online auction website.

15. The system of claim 13, wherein the at least one network site includes an online fixed price website.

16. The system of claim 13, wherein the sales management component further:
receives funds from the buyer to pay for the item;
holds the funds in escrow;
instructs the seller to ship the item to the buyer; and
when the buyer has received the item, releases at least a portion of the funds to the seller.

17. The system of claim 13, wherein the sales management component further sends a message directing packaging materials to be sent to the seller for shipment of the item to the buyer.

18. The system of claim 13, wherein the for-sale listing is listed on the at least one network site under an account that is not associated with the seller.

19. A method in a computing system of allocating one or more boxes for shipment to a seller, the boxes to be used by the seller to ship items to a buyer, the method comprising:
identifying a set of items sold by a seller to a buyer;
retrieving from a data store a dimension and a weight of each item in the set of items;
identifying one or more boxes having a suitable size and construction for holding the set of items based on the retrieved dimension and weight; and
shipping the identified one or more boxes to the seller so that the seller may package the set of items in the one or more boxes and ship the set of items to the buyer.

20. The method of claim 19, further comprising shipping sufficient packing material with the one or more boxes to package the set of items.

21. The method of claim 19, further comprising calculating postage to ship the one or more boxes with the set of items from the seller to the buyer.

22. The method of claim 21, wherein calculating postage to ship the one or more boxes with the set of items from the seller to the buyer includes calculating postage based at least partially upon the weight of each item and the size of each of the one or more boxes.

23. The method of claim 21, further comprising providing the postage with the one or more boxes to facilitate the shipment of the one or more items by the seller.

24. The method of claim 19, further comprising calculating postage for shipping the one or more boxes to the seller.

25. The method of claim 19, further comprising:
identifying a second set of items sold by the seller to a second buyer;
retrieving from the data store a dimension and a weight of each item in the second set of items;
identifying one or more boxes having a suitable size and construction for holding the second set of items based on the retrieved dimension and weight; and
shipping the identified one or more boxes to the seller so that the seller may package the second set of items in the one or more boxes and ship the second set of items to the second buyer.

26. The method of claim 25, wherein at least one box suitable for holding the second set of items is shipped to the seller in a selected box of the one or more boxes for holding the first set of items.

27. The method of claim 26, wherein the size of the selected box is increased to accommodate the at least one box suitable for holding the second set of items.

28. The method of claim 27, wherein the size of the selected box may be increased up to a threshold size that is based at least partially upon a cost of shipping a box of the threshold size.

29. The method of claim 19, wherein the one or more boxes are identified to minimize shipping costs.

30. The method of claim 19, wherein the one or more boxes are identified to minimize the number of boxes.

31. A system for allocating one or more boxes for shipment to a seller, the boxes to be used by the seller to ship items to a buyer, the system comprising:
a packaging optimizer for identifying a set of items sold by a seller to a buyer, retrieving from a data store a dimension and a weight of each item in the set of items, and identifying one or more boxes having a suitable size and construction for holding the set of items based on the retrieved dimension and weight; and
a shipping component for causing the identified one or more boxes to be shipped to the seller so that the seller may package the set of items in the one or more boxes and ship the set of items to the buyer.

32. The system of claim 31, wherein the shipping component further causes sufficient packing material to be shipped with the one or more boxes to package the set of items.

33. The system of claim 31, wherein the shipping component further calculates postage for shipping the one or more boxes with the set of items from the seller to the buyer.

34. The system of claim 33, wherein the shipping component calculates postage for shipping the one or more boxes with the set of items from the seller to the buyer based at least partially upon the weight of each item and the size of each of the one or more boxes.

35. The system of claim 33, wherein the shipping component further causes the postage to be shipped with the one or more boxes to facilitate the shipment of the one or more items by the seller.

36. The system of claim 31, wherein the shipping component further calculates postage for shipping the one or more boxes to the seller.

37. The system of claim 31, wherein the packaging optimizer further identifies a second set of items sold by the seller to a second buyer, retrieves from the data store a dimension and a weight of each item in the second set of items, and identifies one or more boxes having a suitable size and construction for holding the second set of items, and wherein the shipping component further causes the one or more boxes to be shipped to the seller so that the seller may package the second set of items in the one or more boxes and ship the second set of items to the second buyer.

38. The system of claim 31, wherein at least one box suitable for holding the second set of items is caused by the shipping component to be shipped to the seller in a selected box of the one or more boxes for holding the first set of items.

39. The system of claim 31, wherein the packaging optimizer causes the size of the selected box to be increased to accommodate the at least one box suitable for holding the second set of items.

40. The system of claim 31, wherein the packaging optimizer causes the size of the selected box to be increased up to a threshold size that is based at least partially upon a cost of shipping a box of the threshold size.

41. The system of claim 31, wherein the packaging optimizer identifies the one or more boxes to minimize shipping costs.

42. The system of claim 31, wherein the packaging optimizer identifies the one or more boxes to minimize the number of boxes.
